(19) United States
(12) Patent Application Publication
(10) Pub. No.: US 2025/0062557 A1
(43) Pub. Date: Feb. 20, 2025

(54) ELECTRICAL-CONNECTOR EQUIPPED CABLE

(71) Applicant: Sumitomo Electric Industries, Ltd., Osaka-shi (JP)

(72) Inventors: Chiaki KOJIMA, Kanuma-shi (JP); Tatsuo MATSUDA, Kanuma-shi (JP); Masaki SUZUKI, Osaka-shi (JP)

(73) Assignee: Sumitomo Electric Industries, Ltd., Osaka-shi (JP)

(21) Appl. No.: 18/791,511

(22) Filed: Aug. 1, 2024

(30) Foreign Application Priority Data
Aug. 14, 2023 (JP) 2023-131968

(51) Int. Cl. H01R 12/77; H01B 7/08

(52) U.S. Cl. CPC H01R 12/771; H01B 7/0823

(57) ABSTRACT

An electrical-connector-equipped cable includes a flat cable and a connector. The flat cable includes a plurality of conductors arranged side by side, and a first dielectric covering the plurality of conductors to expose a distal end portion of each of the plurality of conductors. The connector holds the distal end portion of each of the plurality of conductors to expose a distal end surface of each distal end portion to an outside. A first opening is provided in the connector. The first opening exposes the distal end portion of at least one first conductor of the plurality of conductors. The distal end portion of the first conductor is positioned in the first opening, and a second dielectric is provided between a wall defining the first opening and the first conductor.

### REFERENCE TO RELATED APPLICATIONS

The present application claims priority based on Japanese Patent Application No. 2023-131968, filed on Aug. 14, 2023, the entire contents of which are incorporated herein by reference.

### TECHNICAL FIELD

The present disclosure relates to an electrical-connector-equipped cable.

### BACKGROUND OF THE INVENTION

WO 2019/208091 discloses a connector including a signal line and a ground line, and an insulating layer covering the signal line and the ground line such that distal end portions thereof are exposed.

### SUMMARY OF THE INVENTION

As one aspect, the present disclosure relates to an electrical-connector-equipped cable. The electrical-connector-equipped cable includes a cable and a connector. The cable includes a plurality of conductors arranged side by side, and a first dielectric covering the plurality of conductors to expose a distal end portion of each of the plurality of conductors. The connector holds the distal end portion of each of the plurality of conductors to expose a distal end surface of each distal end portion to an outside. A first opening is provided in the connector. The first opening exposes the distal end portion of at least one first conductor of the plurality of conductors. The distal end portion of the first conductor is positioned in the first opening, and a second dielectric is provided between a wall defining the first opening and the first conductor.

### BRIEF DESCRIPTION OF THE DRAWINGS

FIG. 1 is a perspective view illustrating an electrical-connector-equipped flat cable according to a first embodiment.

FIG. 2 is a top view illustrating a flat cable used for the electrical-connector-equipped flat cable illustrated in FIG. 1.

FIG. 3 is a perspective view illustrating an electrical-connector-equipped flat cable according to a second embodiment.

### DETAILED DESCRIPTION

### [Problem to be Solved by Present Disclosure]

In the connector disclosed in WO 2019/208091, the signal line is connected to a counterpart connector or the like via a signal line contact member, and thus, a signal is transmitted between the connector and the counterpart connector or the like. In such a connector, connection is performed via the contact member, and thus stubs (signal branches) are generated and transmission characteristics may be deteriorated. Therefore, it is desired to improve the transmission characteristics.

### [Effects of Present Disclosure]

According to the present disclosure, it is possible to provide an electrical-connector-equipped cable capable of improving the transmission characteristics.

### Description of Embodiments of Present Disclosure

First, contents of an embodiment of the present disclosure are listed and described.

[1] A electrical-connector-equipped cable according to the embodiment of the present disclosure includes a cable and a connector. The cable includes a plurality of conductors arranged side by side, and a first dielectric covering the plurality of conductors to expose a distal end portion of each of the plurality of conductors. The connector holds the distal end portion of each of the plurality of conductors to expose a distal end surface of each distal end portion to an outside. A first opening is provided in the connector. The first opening exposes the distal end portion of at least one first conductor of the plurality of conductors. The distal end portion of the first conductor is positioned in the first opening, and a second dielectric is provided between a wall defining the first opening and the first conductor.

In the electrical-connector-equipped cable, the connector holds the plurality of conductors such that the distal end surface of each of the plurality of conductors is exposed to the outside. Thus, when the electrical-connector-equipped cable is connected to a counterpart member (for example, a substrate on which a connection terminal is formed or a counterpart electrical connector), each distal end surface of the plurality of conductors can be directly connected to the terminal of the counterpart member. As a result, it is possible to decrease the generation of stubs (signal branches) generated in a case where a portion other than the distal end surfaces of the plurality of conductors and the terminal of the counterpart member electrically come into contact with each other. According to this electrical-connector-equipped cable, transmission characteristics can be improved. In addition, a second dielectric is provided around the first conductor disposed in the first opening provided in the connector, in the electrical-connector-equipped cable. In this case, an impedance in a portion of the first conductor covered with the second dielectric can be easily matched with an impedance in a portion of the first conductor covered with the first dielectric. As a result, an impedance in the first conductor is matched, and the transmission characteristics can be further improved.

[2] In the electrical-connector-equipped cable according to the above [1], a relative permittivity of a dielectric material forming the second dielectric may be a value between 0.9 and 1.1 with respect to a relative permittivity of a dielectric material forming the first dielectric. In this case, it is easier to match an impedance in a portion covering the first conductor with the first dielectric and an impedance in a portion covering the first conductor with the second dielectric in the cable. As a result, an impedance in the first conductor is adjusted, and the transmission characteristics can be further improved.

[3] In the electrical-connector-equipped cable according to the above [1] or [2], the distal end surface of the first conductor may be positioned on the same plane with respect to an end surface of the second dielectric. When the electrical-connector-equipped cable is connected to the counterpart member, it is possible to further decrease the generation of stubs generated in a case where a portion other than the distal end surface of the first conductor and the terminal of the counterpart member electrically come into contact with each other.

[4] In the electrical-connector-equipped cable according to any one of the above [1] to [3], the connector may include an electric conductive portion made of an electric conductive material. A second opening may be provided in the connector. The second opening may expose the distal end portion of a second conductor of the plurality of conductors. The distal end portion of the second conductor may be positioned in the second opening, and the second conductor may be electrically connected to the electric conductive portion. In this case, noise generated from the conductor held by the holding portion or noise propagated to the conductor can be reduced. Thus, the transmission characteristics can be further improved.

[5] In the electrical-connector-equipped cable according to the above [4], an electric conductor may be provided between a wall defining the second opening and the second conductor, and the second conductor may be electrically connected to the electric conductive portion of the connector through the electric conductor. In this case, noise generated from the conductor held by the holding portion or noise propagated to the conductor can be reduced. Thus, the transmission characteristics can be further improved.

[6] In the electrical-connector-equipped cable according to the above [5], the distal end surface of the second conductor may be positioned on the same plane or protrude outward from the same plane with respect to an end surface of the electric conductor. In this case, the second conductor can function as a ground line to be reliably connected to the ground.

### Details of Embodiment of Present Disclosure

Specific examples of the electrical-connector-equipped cable according to the present embodiment will be described with reference to the drawings as necessary. The present invention is not limited to these examples, but is indicated by the claims, and is intended to include all modifications within the meaning and scope equivalent to the claims. In the following description, the same elements are denoted by the same reference signs in the description of the drawings, and redundant description will be omitted.

### First Embodiment

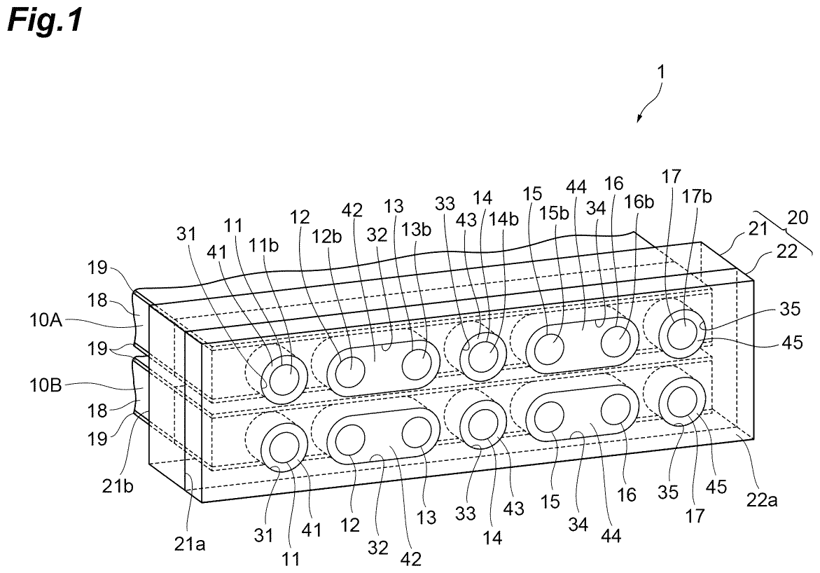

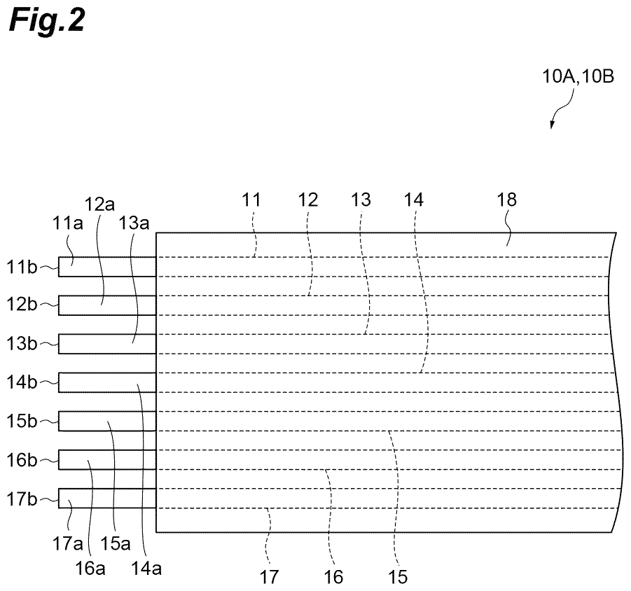

FIG. 1 is a perspective view illustrating an electrical-connector-equipped flat cable according to a first embodiment. FIG. 2 is a top view of a flat cable used in the electrical-connector-equipped flat cable illustrated in FIG. 1. As illustrated in FIGS. 1 and 2, an electrical-connector-equipped flat cable 1 includes flat cables 10A and 10B and a connector 20. The connector 20 includes a connector body 21 and a distal end connector 22. The distal end connector 22 is fixed to a front surface 21a of the connector body 21 with an adhesive or the like. The flat cable 10B has a configuration similar to a configuration of the flat cable 10A. Thus, hereinafter, the flat cable 10A will be described in detail, and the description of the flat cable 10B may be omitted.

The flat cable 10A is, for example, a flexible flat cable (FFC). The flat cable 10A includes a plurality of conductors 11, 12, 13, 14, 15, 16, and 17, and a dielectric 18 (first dielectric) covering the plurality of conductors 11 to 17. The plurality of conductors 11 to 17 is arranged side by side to be separated from each other at a predetermined interval, and are insulated from each other by a dielectric 18. The plurality of conductors 11 to 17 is made of, for example, a conductive metal such as copper, tin-plated soft copper, or nickel-plated soft copper, and have a circular or square sectional shape. A diameter or a maximum width of such conductors 11 to 17 may be less than or equal to 350 μm, may be less than or equal to 300 μm, or may be more than or equal to 100 μm. The plurality of conductors 11 to 17 is either signal conductors or ground conductors. In the present embodiment, for example, the pair of conductors 12 and 13 (first conductors) and the pair of conductors 15 and 16 (first conductors) are used as the signal conductors (for example, differential signal lines), and the conductors 11, 14, and 17 (second conductors) are used as the ground conductors (ground lines). The number of conductors included in the flat cable 10A is not limited to the number (for example, 7) illustrated in FIGS. 1 and 2, and may be two or more. Array orders of the signal conductors and the ground conductors included in the flat cable 10A are not limited to array orders illustrated in FIGS. 1 and 2, and various arrays can be applied.

As illustrated in FIG. 2, the plurality of conductors 11 to 17 includes distal end portions 11a, 12a, 13a, 14a, 15a, 16a, and 17a, respectively. Each of the distal end portions 11a to 17a is a portion held by the connector 20 to be described in detail later. In the distal end portions 11a to 17a, coating by the dielectric 18 is removed, and the conductor portion is exposed. Distal end surfaces 11b, 12b, 13b, 14b, 15b, 16b, and 17b are provided in distal ends of the distal end portions 11a to 17a, respectively. The distal end surfaces 11b to 17b are regions directly connected to a counterpart terminal when the electrical-connector-equipped flat cable 1 is connected to a counterpart member (a substrate or the like having a connection terminal on a front surface).

The dielectric 18 is a portion that covers and protects the plurality of conductors 11 to 17. The dielectric 18 is formed to insulate the conductors 11 to 17 from each other. The dielectric 18 can be made of, for example, a dielectric material having a relative permittivity of 2.3 or less and a dielectric loss tangent of 0.0014 or less. The conductors 11 to 17 are covered with the dielectric material having the relative permittivity and dielectric loss tangent described above, an impedance in the conductors 11 to 17 is matched with an impedance in a portion where the dielectric 18 of the flat cable 10A or 10B is present. The dielectric material forming the dielectric 18 is, for example, a resin composition containing, as a main component, polyolefin, polyester, or olefinic thermoplastic elastomer. However, the dielectric material forming the dielectric 18 is not limited thereto, and various materials can be used as long as the impedance in the conductors 11 to 17 can be reduced. The dielectric 18 may be formed by bonding a pair of films made of such a dielectric material to both surfaces of the plurality of conductors 11 to 17, or may be formed by extruding such a dielectric material with respect to the plurality of conductors 11 to 17. The impedance is matched with a flat cable body portion (a portion where the dielectric 18 is present) at the distal end portions 11a to 17a of the conductors 11 to 17, and thus, a loss and a crosstalk of a signal transmitted by the flat cable are decreased.

The flat cable 10A may further include a shield layer 19 disposed outside the dielectric 18. Such a shield layer 19 may be formed to cover substantially the entire dielectric 18. The shield layer 19 is provided, and thus, it is possible to prevent external noise from entering the plurality of conductors 11 to 17 and to secure high frequency characteristics. Such a shield layer 19 can be made of, for example, a metal foil such as a copper foil or an aluminum foil, and can be attached to the outside of the dielectric 18 with an adhesive. The shield layer 19 is electrically connected to the metallic connector body 21 or a metal shell, and is further connected to the metallic distal end connector. In this case, the shield layer 19 is connected to a ground circuit through the distal end connector.

The connector body 21 of the connector 20 is a cylindrical member having a rectangular parallelepiped outer shape, and is a member that holding the conductors 11 to 17 of each of the flat cables 10A and 10B. An insertion hole 21b is provided in the connector body 21 from the rear toward the front, and the flat cables 10A and 10B are inserted into the insertion hole 21b. At this time, in the connector body 21, the flat cables 10A and 10B are integrally held by the insertion hole 21b on a rear end side, and parts of the distal end portions of the corresponding conductors 11 to 17 are disposed in individual through-holes extending forward from the insertion hole 21b on a front end side (a portion close to the distal end connector 22). A plurality of through-holes provided in the connector body 21 can communicate with a plurality of openings 31 to 35 provided in the distal end connector 22, and the conductors 11 to 17 having passed through the individual through-holes provided in the connector body 21 can be exposed to the outside. Since such a connector body 21 is required to be precisely molded, the connector body is made of, for example, polyphenylene sulfide (PPS) or the like. A dielectric constant of the PPS is, for example, 3.6, and is a dielectric constant higher than the dielectric 18. The connector body 21 may be made of metal, and the connector body 21 may be covered with a metal shell.

The distal end connector 22 is an auxiliary connector attached to the front surface 21a of the connector body 21, and two sets of openings 31, 32, 33, 34, and 35 through which the distal end portions 11a to 17a of the conductors 11 to 17 pass are formed vertically. The two sets of openings 31 to 35 pass through two flat cables 10A and 10B. In a case where the conductors 11, 14, and 17 are, for example, the ground conductors, the openings 31, 33, and 35 may correspond to the conductors 11, 14, and 17 on a one-to-one basis. In the openings 31, 33, and 35, the distal end portions 11a, 14a, and 17a of the conductors 11, 14, and 17 are exposed to the outside. In a case where the pair of conductors 12 and 13 and the pair of conductors 15 and 16 are the signal conductors such as the differential signal lines, the openings 32 and 34 may correspond to the pair of conductors 12 and 13 and the pair of conductors 15 and 16. In the openings 32 and 34, the distal end portions 12a, 13a, 15a, and 16a of the conductors 12, 13, 15, and 16 are exposed to the outside. The distal end connector 22 is made of metal such as aluminum, stainless steel, or copper, for example, and functions as a ground electrode. In a case where the connector body 21 is made of metal, the connector body 21 and the distal end connector 22 may be an integrated connector.

Dielectrics 42 and 44 (second dielectrics) are embedded in the openings 32 and 34 of the distal end connector 22. That is, the dielectric 42 is disposed between the pair of conductors 12 and 13 and a wall (peripheral wall) defining the opening 32, and the dielectric 44 is disposed between the pair of conductors 15 and 16 and a wall (peripheral wall) defining the opening 34. The dielectrics 42 and 44 can be made of a material similar to the dielectric 18. In this case, for example, a dielectric constant of a dielectric material forming the dielectrics 42 and 44 may be in a range of 0.9 to 1.1 with respect to a dielectric constant of a dielectric material forming the dielectric 18. The dielectrics 42 and 44 may be made of a dielectric material having a relative permittivity lower than the dielectric 18. The dielectrics 42 and 44 can be made of, for example, a UV curable resin. In this case, the UV curable resin to be the dielectrics 42 and 44 is poured into the openings 32 and 34 and is UV-cured to fix the pair of conductors 12 and 13 and the pair of conductors 15 and 16. At this time, the dielectrics 42 and 44 are formed such that the distal end surfaces 12b and 13b of the pair of conductors 12 and 13 are positioned on substantially the same plane as an end surface of the dielectric 42 and the distal end surfaces 15b and 16b of the pair of conductors 15 and 16 are positioned on substantially the same plane as an end surface of the dielectric 44. The dielectrics 42 and 44 may be formed such that the end surfaces of the dielectrics 42 and 44 are positioned on the same plane as a front surface 22a of the distal end connector 22. The dielectrics 42 and 44 may be formed in advance, and the dielectrics 42 and 44 may be fitted between the pair of conductors 12 and 13 and the opening 32 or between the pair of conductors 15 and 16 and the opening 34. The dielectrics 42 and 44 may be made of a thermoplastic resin or a thermosetting resin. Depending on a structure of connection points of counterparts (receptacles) to which the conductors 12, 13, 15, and 16 are electrically connected, the distal end surfaces 12b, 13b, 15b, and 16b of the conductors 12, 13, 15, and 16 and the end surfaces of the dielectrics 42 and 44 may not be completely the same plane, and a deviation of several μm is allowed.

Electric conductors 41, 43, and 45 are embedded in the openings 31, 33, and 35 of the distal end connector 22. That is, the electric conductor 41 is disposed between the conductor 11 and a wall (peripheral wall) defining the opening 31, the electric conductor 43 is disposed between the conductor 14 and a wall (peripheral wall) defining the opening 33, and the electric conductor 45 is disposed between the conductor 17 and a wall (peripheral wall) defining the opening 35. The electric conductors 41, 43, and 45 can be made of a conductive resin or a metal material. At this time, the electric conductors 41, 43, and 45 are formed such that the distal end surface 11b of the conductor 11 is positioned on the same plane as an end surface of the electric conductor 41, the distal end surface 14b of the conductor 14 is positioned on the same plane as an end surface of the electric conductor 43, and the distal end surface 17b of the conductor 17 is positioned on the same plane as an end surface of the electric conductor 45. The electric conductors 41, 43, and 45 may be formed such that the end surfaces of the electric conductors 41, 43, and 45 are positioned on the same plane as the front surface 22a of the distal end connector 22. The conductors 11, 14, and 17 may protrude outward from the end surfaces of the electric conductors 41, 43, and 45. Depending on a structure of connection points of counterparts (receptacles) to which the conductors 11, 14, and 17 are electrically connected, the distal end surfaces 11b, 14b, and 17b of the conductors 11, 14, and 17 and the end surfaces of the electric conductors 41, 43, and 45 may not be completely the same plane, and a deviation of several μm is allowed.

In the distal end connector 22, the electric conductors 41, 43, and 45 electrically connect the conductors 11, 14, and 17 to the metallic distal end connector 22. As a result, in a case where the conductors 11, 14, and 17 are used as the ground conductors, the distal end connector 22 serving as the ground and the conductors 11, 14, and 17 serving as the ground conductors become potentially the same and are grounded. In a case where shapes of the openings 31, 33, and 35 substantially coincide with the distal end portions of the conductors 11, 14, and 17, the conductors 11, 14, and 17 may be directly connected to the distal end connector 22 functioning as the ground without embedding the electric conductors 41, 43, and 45 (or by embedding an extremely small amount of conductive material).

### Second Embodiment

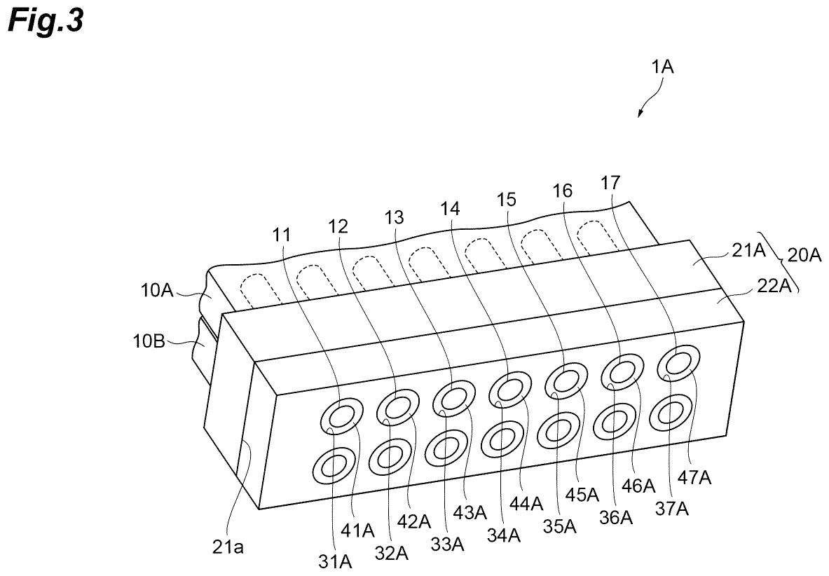

Next, an electrical-connector-equipped flat cable 1A according to a second embodiment will be described with reference to FIG. 3. FIG. 3 is a perspective view illustrating an electrical-connector-equipped flat cable according to a second embodiment. Hereinafter, differences from the electrical-connector-equipped flat cable 1 according to the first embodiment will be mainly described, and other descriptions may be omitted.

As illustrated in FIG. 3, the electrical-connector-equipped flat cable 1A includes flat cables 10A and 10B and a connector 20A. Each of the flat cables 10A and 10B includes the conductors 11 to 17. The connector 20A includes a connector body 21A and a distal end connector 22A. The distal end connector 22A is fixed to a front surface 21a of the connector body 21A with an adhesive or the like. In the electrical-connector-equipped flat cable 1A, all the conductors 11 to 17 included in the flat cables 10A and 10B are signal conductors. Thus, similarly to the distal end connector 22 of the connector 20, two sets of a plurality of openings 31A, 32A, 33A, 34A, 35A, 36A, and 37A are provided in the distal end connector 22A. Through-holes corresponding to the plurality of openings 31A to 37A may be provided in the connector body 21A. These openings 31A to 37A correspond to the conductors 11 to 17 on a one-to-one basis. Unlike the first embodiment, the distal end connector 22A is made of resin such as PPS similarly to the connector body 21A. (As in the first embodiment, the distal end connector may be made of metal.) In the electrical-connector-equipped flat cable 1A, dielectrics 41A, 42A, 43A, 44A, 45A, 46A, and 47A are provided between the conductors 11 to 17 and walls defining the corresponding openings 31A to 37A. These dielectrics 41A to 47A correspond to, for example, the dielectrics 42 and 44 of the first embodiment. As a result, as in the first embodiment, in the electrical-connector-equipped flat cable 1A, the impedance in the signal conductor is adjusted.

Hereinabove, although the embodiment of the present disclosure has been described in detail, the present disclosure is not limited to the above embodiment, and can be applied to various embodiments. For example, in the above embodiment, although the two flat cables 10A and 10B are held by the connector 20, the number of flat cables 10A and 10B included in the electrical-connector-equipped flat cable 1 is not particularly limited, and may be one flat cable or three or more flat cables.

In the above-described embodiment, although the case where the connectors 20 holding the flat cables 10A and 10B have the same configuration (the arrays of the ground conductor and the signal conductor are the same) in the flat cables 10A and 10B has been described, the array orders of the conductors (the ground conductor and the signal conductor) in the flat cable 10A and the flat cable 10B may be different. For example, the flat cable 10A may include only the signal conductors, and the flat cable 10B may include the ground conductor and the signal conductor. In such a case, although the disposition of the openings 31 to 35 provided in the connector 20 may be changed accordingly, this point is clear to those skilled in the art and the description will be omitted.

What is claimed is:

1. An electrical-connector-equipped cable, comprising:
a cable including a plurality of conductors arranged side by side and a first dielectric covering the plurality of conductors to expose a distal end portion of each of the plurality of conductors; and
a connector holding the distal end portion of each of the plurality of conductors to expose a distal end surface of each distal end portion to an outside, wherein a first opening is provided in the connector, the first opening exposing the distal end portion of at least one first conductor of the plurality of conductors,
wherein the distal end portion of the first conductor is positioned in the first opening, and a second dielectric is provided between a wall defining the first opening and the first conductor.

2. The electrical-connector-equipped cable according to claim 1,
wherein a relative permittivity of a dielectric material forming the second dielectric is a value between 0.9 and 1.1 with respect to a relative permittivity of a dielectric material forming the first dielectric.

3. The electrical-connector-equipped cable according to claim 1,
wherein the distal end surface of the first conductor is positioned on the same plane with respect to an end surface of the second dielectric.

4. The electrical-connector-equipped cable according to claim 1,
wherein the connector includes an electric conductive portion made of an electric conductive material,
wherein a second opening is provided in the connector, the second opening exposing the distal end portion of a second conductor of the plurality of conductors, and
wherein the distal end portion of the second conductor is positioned in the second opening, and the second conductor is electrically connected to the electric conductive portion.

5. The electrical-connector-equipped cable according to claim 4,
wherein an electric conductor is provided between a wall defining the second opening and the second conductor, and the second conductor is electrically connected to the electric conductive portion through the electric conductor.

6. The electrical-connector-equipped cable according to claim 5,
wherein the distal end surface of the second conductor is positioned on the same plane with respect to an end surface of the electric conductor or protrudes outward from the same plane.

7. The electrical-connector-equipped cable according to claim 1,
wherein the at least one first conductor includes a plurality of first conductors, and the second dielectric fixes the plurality of first conductors.

8. The electrical-connector-equipped cable according to claim 1,
wherein the plurality of conductors include at least two ground conductors configured to be connected to a ground and at least one signal conductor configured to propagate electric signals, and the signal conductor is disposed between the ground conductors.

9. The electrical-connector-equipped cable according to claim 1,
wherein the second dielectric are formed from a UV curable resin.

10. The electrical-connector-equipped cable according to claim 1,
wherein a relative permittivity of a dielectric material forming the second dielectric is lower than a relative permittivity of a dielectric material forming the first dielectric.
